(19) United States
(12) Patent Application Publication
(10) Pub. No.: US 2018/0233767 A1
(43) Pub. Date: Aug. 16, 2018

(54) Sodium-Based Battery for Power Tool

(71) Applicant: Sunrise Global Marketing, Mooresville, NC (US)

(72) Inventor: Greg Arnold, Huntersville, NC (US)

(21) Appl. No.: 15/433,454

(22) Filed: Feb. 15, 2017

(51) Int. Cl. H01M 10/054; H01M 2/10; B25F 5/00

(52) U.S. Cl. CPC H01M 10/054; H01M 2220/30; B25F 5/00; H01M 2/1055

(57) ABSTRACT

A sodium-based battery cell may be provide an amount of energy to power a power tool. A plurality of sodium-based battery cells may be provided in a battery pack that may be connected to electrical equipment, such as a power tool. Each of the plurality of sodium-based battery cells also may be rechargeable.

### TECHNICAL FIELD

The disclosure relates generally to batteries that may be sodium-based. In particular, the disclosure relates to a rechargeable, sodium-based battery that may provide power to power tools.

### BACKGROUND

Power tools are typically powered by battery cells that can have a lithium-based chemistry. Lithium can be a rare chemical element and less prevalent in several geographic locations than other elements. The lack of availability of lithium can result in lithium-based battery cells or lithium ion batteries being expensive to manufacture compared to cells having other chemistry, such as nickel and sodium. Additionally, lithium-based battery cells or lithium ion batteries can pose safety hazards and require being operated with protection circuitry.

### SUMMARY

Embodiments of the present disclosure may provide a battery cell that may be sodium-based, rechargeable, and having an amount of energy to power equipment. In some embodiments of the present disclosure, equipment may be a handheld power tool. However, it should be appreciated that there may be embodiments of the present disclosure where the equipment may not be a power tool. By being sodium-based (i.e., based on sodium-ion chemistry), the battery or battery cell may provide a low specific energy and may eliminate risk of fire and explosion.

Other embodiments of the present disclosure may provide a battery pack including a plurality of sodium-based battery cells. The battery pack may provide an amount of energy to power equipment, such as a power tool. In some embodiments of the present disclosure, equipment may be a handheld power tool. In some embodiments of the present disclosure, the plurality of sodium-based battery cells may form a battery pack that is rechargeable. By being sodium-based, each of the plurality of battery cells may provide a low specific energy and may eliminate risk of fire and explosion.

Further embodiments of the present disclosure may provide an electrical combination including a plurality of sodium-based battery cells and a power tool connected to a battery pack including the battery cells. The battery pack may provide a housing that may support the battery cells. In some embodiments of the present disclosure, the power tool may be handheld. By being sodium-based, each of the plurality of battery cells may provide a low specific energy and may eliminate risk of fire and explosion.

Other technical features may be readily apparent to one skilled in the art from the following drawings, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 depicts a perspective view of a sodium-based battery pack according to an embodiment of the present disclosure;

FIG. 2 depicts a sodium-based battery pack connected to electrical equipment according to an embodiment of the present disclosure; and

FIG. 3 depicts a top view of an arrangement of a plurality of sodium-based battery cells according to an embodiment of the present disclosure.

### DETAILED DESCRIPTION

The present disclosure generally provides a sodium-based battery that may provide power to a power tool. When referring to a sodium-based battery, or variations thereof, it should be appreciated that “sodium-based” may include sodium-ion and other sodium-type chemistry without departing from the present disclosure. A battery pack may house a plurality of rechargeable, sodium-based battery cells that may provide an amount of energy to power a handheld power tool.

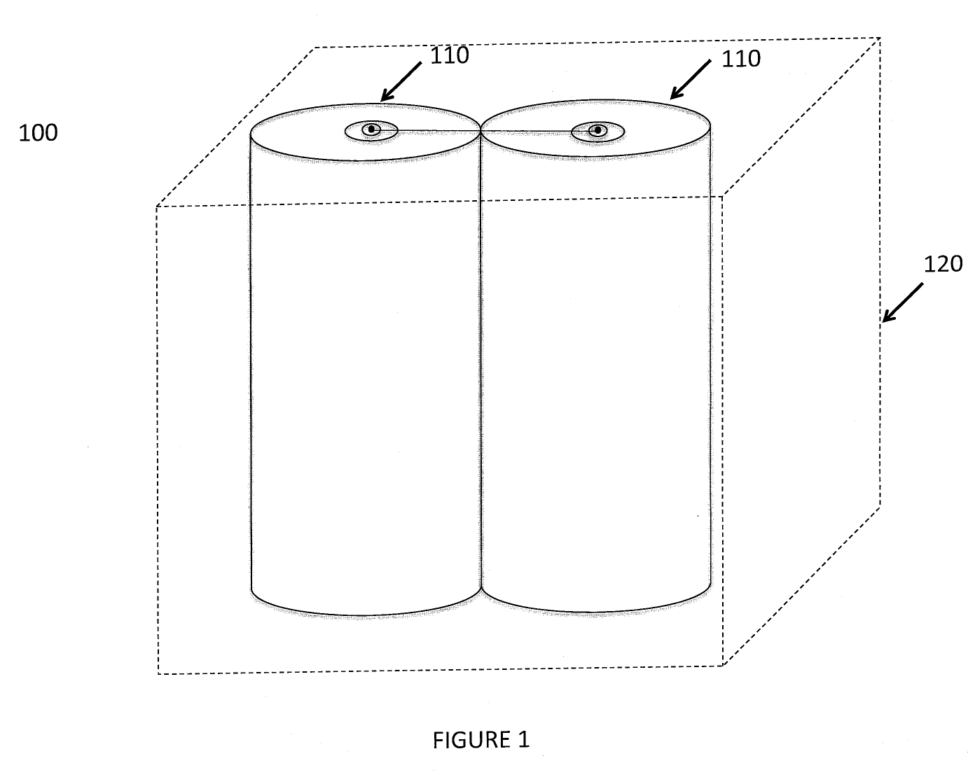

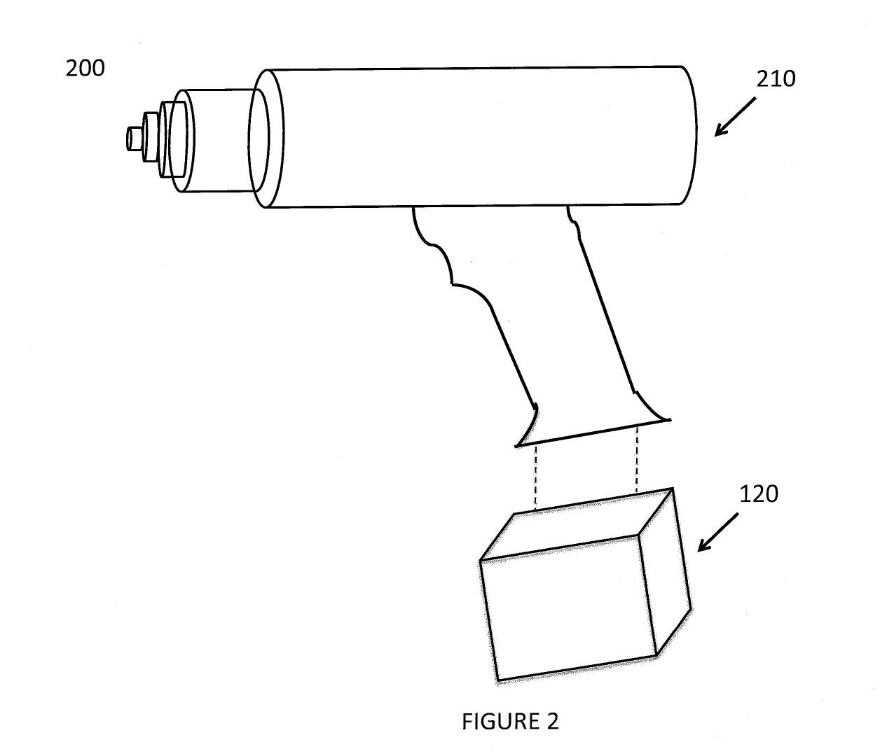

As shown in FIG. 1, according to an embodiment of the present disclosure, battery pack 100 may provide a plurality of rechargeable, sodium-based battery cells 110 that may provide an amount of energy to power to electrical equipment, such as power tool 210 (FIG. 2). Battery pack 100 may be rechargeable by one or more methods, including, but not limited to, by a battery charger. However, it should be appreciated that the plurality of sodium-based chemistry battery cells 110 may not be rechargeable without departing from the present disclosure.

In some embodiments of the present disclosure, battery pack 100 may include housing 120 that may provide support for the plurality of sodium-based battery cells 110. It should be appreciated that housing 120 may be made of any shape, configuration, and/or material.

It should be appreciated that battery pack 100 may have any quantity of sodium-based battery cells 110 in embodiments of the present disclosure. The plurality of sodium-based chemistry battery cells 110 may provide a low specific energy and may eliminate risk of fire and/or explosion. It should be appreciated that sodium-based battery cells 110 may provide aqueous electrolytes or may be non-aqueous in embodiments of the present disclosure. It should be appreciated that the chemistry of the plurality of sodium-based battery cells 110 may be effective for operating handheld power tools. It also should be appreciated that the plurality of sodium-based battery cells 110 may be an effective replacement for battery cells having a different chemistry, such as lithium battery cells, by providing a cheaper and safer alternative.

As shown in FIG. 2, according to an embodiment of the present disclosure, battery pack 100 may be connected to power tool 210 to form battery-run tool 200; however, it should be appreciated that battery pack 100 may be removable from power tool 210 in some embodiments of the present disclosure. It should be appreciated that battery pack 100 including a plurality of sodium-based battery cells 110 (FIG. 1) may be utilized to power devices that may or may not be power tools, including, but not limited to, phones, appliances, computers, and vehicles. It should be appreciated that sodium-based battery cells 110 may provide a storage capacity that may be effective for powering electrical equipment, such as power tool 210.

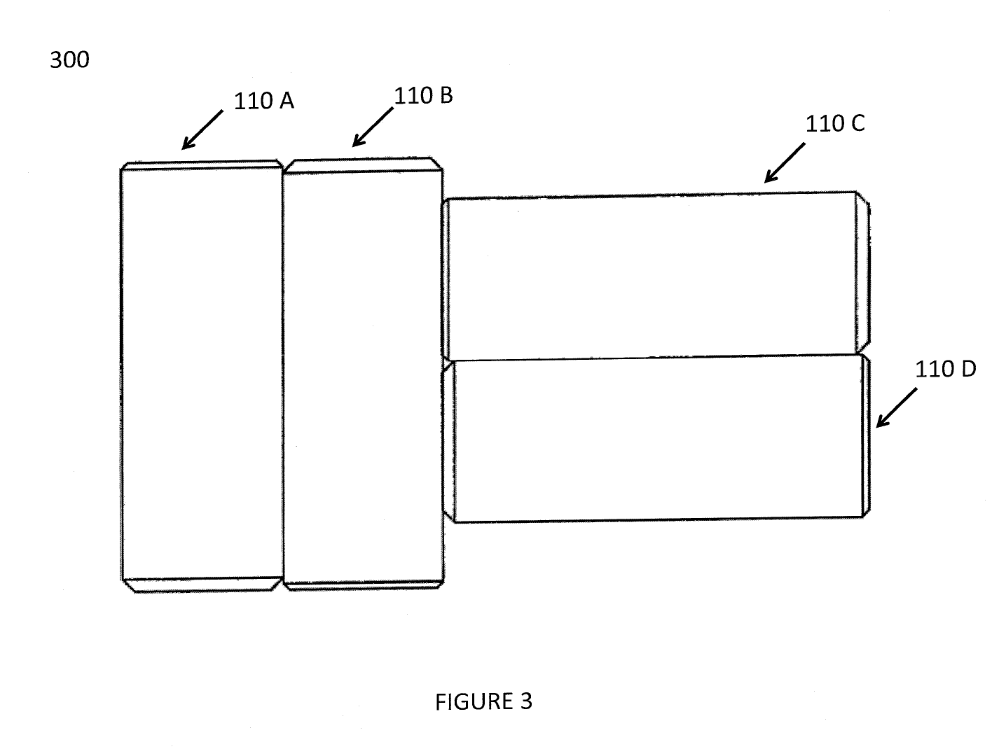

As shown in FIG. 3, according to an embodiment of the present disclosure, a plurality of sodium-based battery cells 110A, 110B of the plurality of sodium-based battery cells 110 (FIG. 1) may be arranged in parallel to each other, and the plurality of sodium-based battery cells 110C, 110D of the plurality of sodium-based battery cells 110 (FIG. 1) may be arranged in parallel to each other. The plurality of sodium-based battery cells 110A, 110B may not be arranged in parallel to the plurality of sodium-based battery cells 110C, 110D. It should be appreciated that the configuration of the plurality of sodium-based battery cells 110A, 110B, 110C, 11D in FIG. 3 represents one configuration; however, the plurality of sodium-based battery cells 110 (FIG. 1) may be arranged in other configurations without departing from the present disclosure.

It should be appreciated that battery pack 100 and/or the plurality of sodium-based battery cells 110 may have any voltage that may be utilized to power electrical equipment. It should be appreciated that each of the plurality of battery cells may have a shape that may be cylindrical and may be arranged in series, in parallel, in a partial serial arrangement, in a partial parallel arrangement, and/or in any combination of a series, parallel, partial series or partial parallel arrangement. It should be appreciated that battery pack 100 may provide a terminal assembly that may be operable to electrically connect a plurality of battery cells to a circuit in the electrical device in embodiments of the present disclosure. The terminal assembly may provide positive battery terminal, a ground terminal, and a sense terminal. Terminals may be connected to the opposite ends of the cell or series of cells in embodiments of the present disclosure.

It should be appreciated that battery pack 100 may have a nominal voltage that may have any value. It should further be appreciated that battery pack 100 may be provided in any structural form or arrangement without departing from the present disclosure. It should be appreciated that battery pack 100 may be configured to transfer power to and receive power from electrical devices, such as power tools and battery chargers without departing from the present disclosure. It should be appreciated that battery pack 100 may supply power to any type of power tool including, but not limited to, air compressors, drills, saws, and handheld blowers. It should be appreciated that circuitry may provided that may electrically power each of the plurality of battery cells 110 or batteries in battery pack 100 in embodiments of the present disclosure.

It may be advantageous to set forth definitions of certain words and phrases used in this patent document. For the purposes of the discussion herein, the terms “battery,” “battery cell,” and “battery pack” encompass any type of sodium-based chemistry including, but not limited to, sodium in combination with other elements, sodium-ion, and pure sodium. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A battery cell that is sodium based, rechargeable and contains an amount of energy to power one or more pieces of equipment.

2. The battery cell of claim 1, wherein the one or more pieces of equipment is a handheld power tool.

3. The battery cell of claim 1, wherein the one or more pieces of equipment is not a power tool.

4. The battery cell of claim 1, wherein by being sodium-based, the battery cell provides a low specific energy and eliminates risk of fire and explosion when the battery cell is in use.

5. A battery pack, comprising:
a plurality of sodium-based battery cells,
wherein the battery pack provides an amount of energy to power at least one power tool.

6. The battery pack of claim 5, wherein the power tool is handheld.

7. The battery pack of claim 5, wherein the battery pack is rechargeable.

8. The battery pack of claim 5, wherein each of the plurality of battery cells provides a low specific energy and eliminates risk of fire and explosion when the battery pack is in use.

9. An electrical combination, comprising:
a battery pack containing a plurality of sodium-based battery cells; and
a power tool connected to the battery pack.

10. The electrical combination of claim 9, wherein the battery pack provides a housing to support the plurality of sodium-based battery cells.

11. The electrical combination of claim 9, wherein the power tool is handheld.

12. The electrical combination of claim 9, wherein the battery pack provides a low specific energy and eliminates risk of fire and explosion when the battery pack is in use.
